(19) United States
(12) Patent Application Publication
(10) Pub. No.: US 2020/0007445 A1
(43) Pub. Date: Jan. 2, 2020

(54) ENHANCED SERVICE FUNCTION CHAIN

(71) Applicant: AT&T Intellectual Property I, L.P., Atlanta, GA (US)

(72) Inventors: Muhammad Bilal Anwer, Branchburg, NJ (US); Yulong Zhou, Green Brook, NJ (US); Bo Han, Bridgewater, NJ (US); David Mahar, Stamford, CT (US); Michael Satterlee, Clifton Park, NY (US); Vijay Gopalakrishnan, Edison, NJ (US)

(21) Appl. No.: 16/023,459

(22) Filed: Jun. 29, 2018

(51) Int. Cl. H04L 12/741

(52) U.S. Cl. CPC H04L 45/74

(57) ABSTRACT

Network function may be dissected and the common functions abstracted into inspection network function as the first hop, for example, of a service function chain. The inspection network function then inserts a value into the network service header (NSH) which may be used for the rest of the network functions of the service function chain.

### BACKGROUND

A service function chain (SFC) may consist of a sequence of network functions (NFs), such as L3 Stateless Firewall, L4 Statefull Firewall, L7 Firewall, Intrusion Detection System (IDS), Intrusion Prevention System (IPS), Web Filtering, Antivirus/Antispyware, WAN Optimizer (WANx), or Load Balancers (LB), among other things. The SFC may stitch these NFs together through pre-defined policy rules, such as a set of NFs may construct a service chain with use cases in various networks. There are multiple ways of steering data flows through a service chain. An example way of steering data flows through a service chain is to physically wire a NFs in a dedicated hardware middlebox and statically place them at manually induced intermediate points. It is cumbersome to reconfigure such a predefined service chain. The advent of Software Defined Networking (SDN) has facilitated traffic steering in SFC, by leveraging logically centralized control plane and providing the programmability for a forwarding plane. Operators have begun to apply network functions virtualization (NFV) to SFC, using Virtual Network Function (VNFs) running on commodity servers. This disclosure is directed to addressing issues in the existing technology.

### SUMMARY

Service Function Chains (SFCs) may include a sequence of virtual network functions (VNFs) that are typically traversed in-order by data flows. The VNFs of a SFC may be deployed in a single physical machine or distributed over multiple servers running in different data centers. A VNF may be dissected into a group of inspection modules and a set of actions. These modules examine data packets processed by a VNF at different levels, such as packet-header filter, content-based Deep Packet Inspection (DPI), session identification, and application identification. The actions may include forwarding, tagging, dropping, or pacing. In addition, the actions may be more complex, such as compression, encryption, or decryption on network traffic. Conventionally, when a number of VNFs are chained together their inspection modules may overlap with each other and thus the same operation may be repeated on data traffic multiple times in a SFC. These VNFs may be dissected and the common functions abstracted into a DPI-like VNF (simply called DPI-VNF) as the first hop, for example, of a SFC. The DPI-VNF then tags an inspection or the like result of a packet into its Network Service Header (NSH) which may be used for the rest of the action-focused VNFs. The disclosed enhanced SFC system may reduce the packet processing latency and increase an SFC throughput. The disclosed system may also further simplify the complexity of VNF-rule specifications and may enable the development of lightweight VNFs.

In an example, an apparatus may include a processor and a memory coupled with the processor that effectuates operations. The operations may include detecting a packet; processing the packet by a deep packet inspection network function (DPI-NF) of a service function chain, wherein the DPI-NF comprises a plurality of modules and wherein the plurality modules are common modules for a plurality virtual network functions of the service function chain; based on the processing of the DPI-NF, appending a network service header to the first packet; and providing instructions to send the packet to a first virtual network function of the plurality of network functions, wherein the first virtual network function executes an action based on the network service header.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE DRAWINGS

Reference will now be made to the accompanying drawings, which are not necessarily drawn to scale.

FIG. 1 illustrates an exemplary system that may use enhanced service function chaining.

FIG. 2 illustrates an exemplary stack for a VNF.

FIG. 3 illustrate an exemplary method for enhanced service function chaining.

FIG. 4 illustrates an exemplary system that may use enhanced service function chaining with multiple modules (e.g., layers).

FIG. 5 illustrates an exemplary system that may use enhanced service function chaining.

FIG. 6 illustrates a schematic of an exemplary network device.

FIG. 7 illustrates an exemplary communication system that provides wireless telecommunication services over wireless communication networks.

FIG. 8A is a representation of an exemplary network.

FIG. 8B is a representation of an exemplary hardware platform for a network.

### DETAILED DESCRIPTION

Service Function Chains (SFCs) may include a sequence of virtual network functions (VNFs) that are typically traversed in-order by data flows. The VNFs of a SFC may be deployed in a single physical machine or distributed over multiple servers running in different data centers. A VNF may be dissected into a group of inspection modules and a set of actions. These modules examine data packets processed by a VNF at different levels, such as packet-header filter, content-based Deep Packet Inspection (DPI), session identification, and application identification. The actions may include forwarding, tagging, dropping, or pacing. In addition, the actions may be more complex, such as compression, encryption, or decryption on network traffic. Conventionally, when a number of VNFs are chained together their inspection modules may overlap with each other and thus the same operation may be repeated on data traffic multiple times in a SFC. These VNFs may be dissected and the common functions abstracted into a DPI-like VNF (simply called DPI-VNF) as the first hop, for example, of a SFC. An example of abstracting DPI-VNF from an SFC of Application Firewall and IDS (Intrusion Detection System) may be where traffic pattern detection functionality code that is common between both VNFs is separated into a single VNF. After detecting an offending application or traffic pattern Firewall's main actions may be to block the traffic whereas the IDS's main action may be to generate an alarm. In this SFC the application detection code may reside in DPI-VNF whereas traffic blocking code may be in firewall and alarm generation may be in IDS VNF. The DPI-VNF then tags an inspection or the like result of a packet into its Network Service Header (NSH) which may be used for the rest of the action-focused VNFs. The disclosed enhanced SFC system may reduce the packet processing latency and increase the SFC throughput. The disclosed system may also further simplify the complexity of VNF-rule specifications and may enable the development of lightweight VNFs.

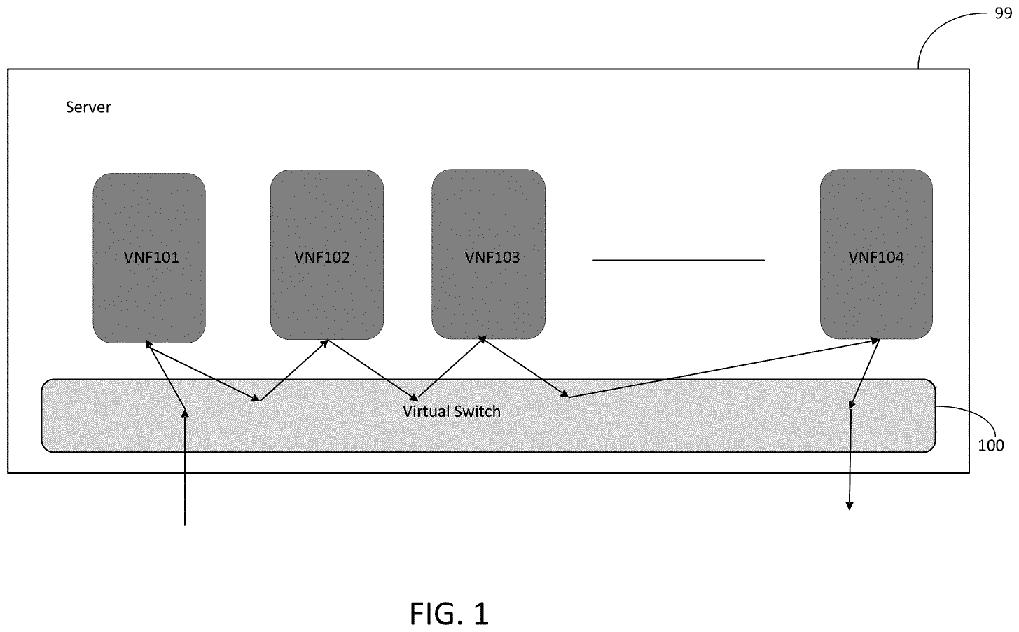

FIG. 1 illustrates an exemplary system that may use enhanced service function chaining, as disclosed herein. As shown, in a SFC environment, VNF 101-VNF 104 are running on a single physical server 99 and VNF 101-VNF 104 are connected through virtual switch 100. VNF 101 (e.g., a layer 7 firewall), VNF 102 (e.g., an IDS), and the other VNFs may process packets at some of the same layers (e.g., layer 2-7) of the open system interconnection model (or the like) and execute some of the same functions, conventionally, as discussed in more detail below.

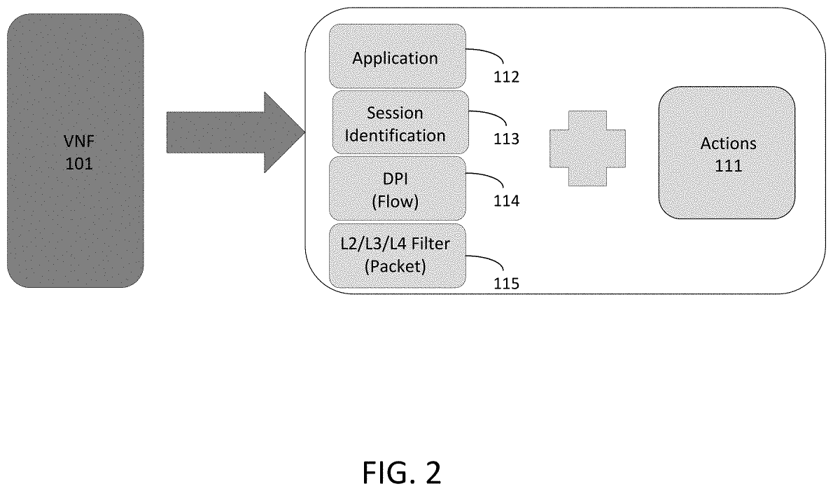

FIG. 2 illustrates an exemplary stack for a VNF. VNF 101 may be considered as a group of inspection modules and a set of actions as shown in FIG. 2. These modules may examine data packets processed by a VNF at different levels, such as packet-header filter, content-based Deep Packet Inspection (DPI), session layer identification, and application identification. The actions may be forwarding, tagging, dropping, or pacing. For example, VNF 101 may be application firewall (e.g., Layer 7 firewall) that is blocks certain network traffic. VNF 101 may first identify application 112 by inspecting the packet header and payload and then executing a packet forward or drop action based on the inspection result. Application detection may involve layer three and four packet filtering for deep packet inspection of the traffic. Based on this inspection various flows (e.g., signaling and media) may be grouped together to identify the session (e.g., voice traffic). An application may have multiple sessions, but these sessions may be used to detect the application presence and define firewall filtering rules. For example, traffic pacers may be used during office hours of an organization to detect peer-to-peer file sharing application traffic and, based on detection, then throttle the bandwidth used by such applications. For both the above applications a common operation is application detection, which may be shared in a SFC. As disclosed herein, actions of blocking and pacing may be applied separately. Action of blocking network traffic can be placed in one container or VM and action of rate limiting or pacing network traffic can be placed into another container or VM.

Conventionally, when a plurality of VNFs are chained together their inspection modules may overlap with each other and thus the same operation may be repeated on data traffic multiple times in a SFC. This repetition of the common operations across the chain may result in a high number of CPU instructions per packet in the same SFC, which ultimately results in low throughput, added latency, or wasted CPU cycles. In addition, the conventional approach may make the rule specification across the service function chain unnecessarily complex.

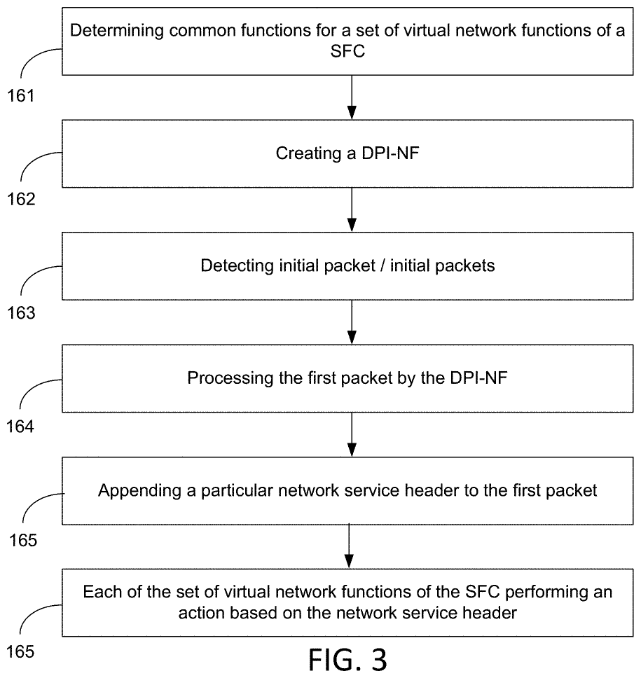

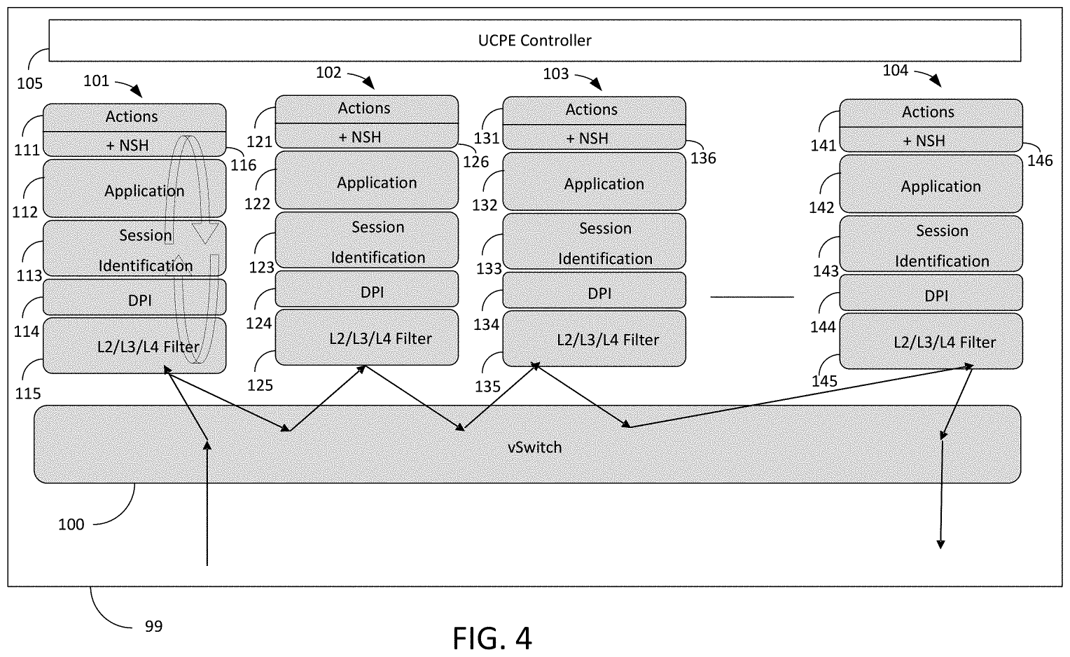

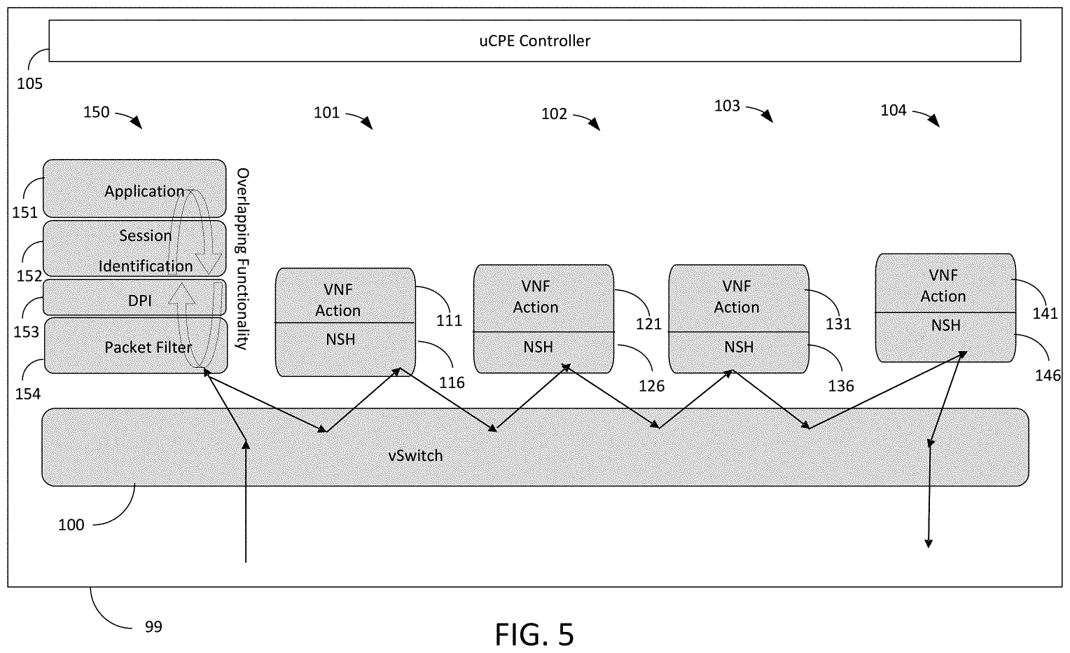

FIG. 3-FIG. 5 illustrate an exemplary method for enhanced service function chaining. At step 161, common function (e.g., common operation) may be determined by a programmer separating and compiling the code again for a set of virtual network functions (e.g., VNF 101-VNF 104) of a SFC. FIG. 4 shows VNF 101-VNF 104 and multiple sub-functions (e.g., modules or layers) that may be used. For this example, module 112-module 115, module 122-module 125, module 132-module 135, and module 142-module 145 may perform the same functions on a packet. It is contemplated that any number of modules may perform the same function, such as just the filter module (e.g., module 115, module 125, module 135, and module 145). At step 162, based on the determined common functions for the set of virtual network functions, creating DPI-NF 150 (FIG. 5), wherein DPI-NF 150 includes the common functions (now module 151-module 154) and DPI-NF 150 is positioned to be executed before the set of virtual network functions (e.g., VNF 101-VNF 104) of the SFC. At step 163, detecting a first packet. The first packet may be one of a plurality of packets for a communication session. At step 164, processing the first packet by DPI-NF 150. The first packet may be processed by each module 151-module 154 of DPI-NF 150.

With continued reference to FIG. 3, at step 165, assigning (or appending) a particular network service header value to the first packet, based on the processing of DPI-NF 150. For example, the first packet may be determined to have the characteristics as shown in Table 1. Based on the characteristics of Table 1, an apparatus (e.g., uCPE controller 105 or an SDN controller which may be virtual) may determine that NSH=10026 should be appended to the first packet and append the first packet accordingly. See for example IETF RFC 8300. Each VNF should be able to read the NSH and understand what each value means. uCPE controller 105 may send info (e.g., list or table), periodically, such as in Table 2, to each VNF to update their interpretation of the NSH. At step 166, each VNF 101-VNF 104 may read the NSH of the first packet and perform an action, based on the NSH, without executing any of the common functions for the set of virtual network functions. So when the flow goes through the next destination VNF (e.g., VNF 101), VNF 101 doesn't have to look at source IP, destination IP, srcPrt, etc. VNF 101 reads the NSH and determines whether to drop the packet, forward it, or perform some other action. See FIG. 5. It is contemplated herein that reading of the NSH would be done before most modules (e.g., before module 122-module 125). Further, there may be scenarios that all application modules of each VNF is different therefore they would be executed, but the session identification, DPI, and packet filter operations may be the same across VNFs. Other combinations are contemplated.

TABLE 1

| | |
|---|---|
| Source IP Address | 10.1.1.1 |
| Destination IP Address | 10.2.1.1 |
| Source Port | 1024 |
| Destination Port | 1024 |
| DPI info | Format Xample |
| Session ID | 1-2-3-4-5 |
| Application ID | ExampleApp |

TABLE 2

| | |
|---|---|
| Drop and log | 10021 |
| Forward | 10022 |
| Encapsulate | 10023 |
| Encrypt | 10024 |
| Decrypt | 10025 |
| Decompress | 10026 |
| Compress | 10027 |

In summary, the disclosed enhanced SFC architecture separates the common functionality modules that appear across different NFs (e.g., VNFs) from them and then abstracts and aggregates those modules into a single NF. By doing this, network traffic may traverse those modules only once and a SFC does not have to do the same work over and over again on the same packet. Here we note that the common modules across NFs in a SFC are not necessarily the same. The overlap between NFs can vary across the SFC. As disclosed, dissecting the NFs of the SFC shown in FIG. 4, we aggregate the modules into a single NF, called DPI-NF 150. Again, uCPE controller 105 (or an SDN controller) may create NSHs (and then notify) based on what the original NFs intend to do (e.g., configuration and policy rules). After the inspection of a packet, DPI-NF 150 may tag the result in the Network Service Header (NSH) of the packet. The rest of action-focused NFs may further process the packet based on the information available in the NSH field.

Apart from aggregating the traffic read operations, packet write operations may also be aggregated, particularly if they are simple. In an example, a SFC may have two network functions, such as firewall and traffic shaper, then packet drop and shaping may be merged to a single VNF. Along with separation of data plane functionality of NFs from specialized action parts, dividing the common functionality into multiple layers enable network operators to specify the packet processing rules at varying abstractions. Described below are various levels of abstraction that may be used. Packet Header Abstraction (e.g., module 154)—rules can be specified in traditional way where fields from packets can be matched at filtering layer. These matches may happen inside the traditional header. DPI Abstraction (e.g., module 153)—with DPI abstraction traffic content may be examined to identify the application layer protocol, which may provide packet payload abstraction. Session abstraction (e.g., module 152) may allow correlation between various protocols (across flows) and to identify a session that is being used by an application. Application abstraction (e.g., module 151) may allow correlation between various sessions and identify an application.

In an example, a method for enhanced service function chaining may include detecting a communication session, wherein the communication session comprises a plurality of data packets; determining the communication session is of a first type of application; determining the communication session comprises a first destination address and a first source address; and based on the communication matching the first type, the first destination address, and the first source address, setting each of the plurality of the data packets to a value in a network service header, the value identifying a way to process the plurality of data packets. The value may be indicative of instructions to drop, forward, or encrypt the plurality of data packets of the communication session. The method may include using a deep packet inspection network function to determine the network service header; and based on a value of the network service header, determining, by the deep packet inspection network function, whether to process a packet of the plurality of data packets of the communication session.

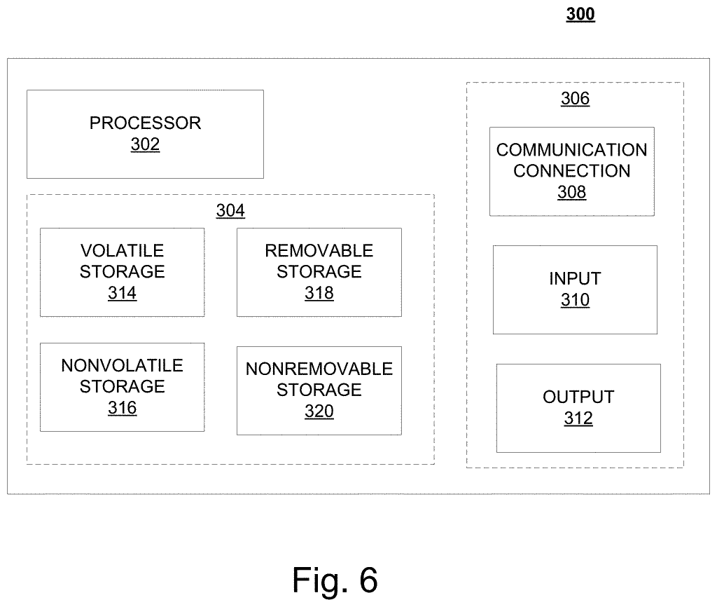

FIG. 6 is a block diagram of network device 300 that may be connected to or comprise a component of FIG. 1. Network device 300 may comprise hardware or a combination of hardware and software. The functionality to facilitate telecommunications via a telecommunications network may reside in one or combination of network devices 300. Network device 300 depicted in FIG. 6 may represent or perform functionality of an appropriate network device 300, or combination of network devices 300, such as, for example, a component or various components of a cellular broadcast system wireless network, a processor, a server, a gateway, a node, a mobile switching center (MSC), a short message service center (SMSC), an automatic location function server (ALFS), a gateway mobile location center (GMLC), a radio access network (RAN), a serving mobile location center (SMLC), or the like, or any appropriate combination thereof. It is emphasized that the block diagram depicted in FIG. 6 is exemplary and not intended to imply a limitation to a specific implementation or configuration. Thus, network device 300 may be implemented in a single device or multiple devices (e.g., single server or multiple servers, single gateway or multiple gateways, single controller or multiple controllers). Multiple network entities may be distributed or centrally located. Multiple network entities may communicate wirelessly, via hard wire, or any appropriate combination thereof.

Network device 300 may comprise a processor 302 and a memory 304 coupled to processor 302. Memory 304 may contain executable instructions that, when executed by processor 302, cause processor 302 to effectuate operations associated with mapping wireless signal strength. As evident from the description herein, network device 300 is not to be construed as software per se.

In addition to processor 302 and memory 304, network device 300 may include an input/output system 306. Processor 302, memory 304, and input/output system 306 may be coupled together (coupling not shown in FIG. 6) to allow communications between them. Each portion of network device 300 may comprise circuitry for performing functions associated with each respective portion. Thus, each portion may comprise hardware, or a combination of hardware and software. Accordingly, each portion of network device 300 is not to be construed as software per se. Input/output system 306 may be capable of receiving or providing information from or to a communications device or other network entities configured for telecommunications. For example input/output system 306 may include a wireless communications (e.g., 3G/4G/GPS) card. Input/output system 306 may be capable of receiving or sending video information, audio information, control information, image information, data, or any combination thereof. Input/output system 306 may be capable of transferring information with network device 300. In various configurations, input/output system 306 may receive or provide information via any appropriate means, such as, for example, optical means (e.g., infrared), electromagnetic means (e.g., RF, Wi-Fi, Bluetooth®, ZigBee®), acoustic means (e.g., speaker, microphone, ultrasonic receiver, ultrasonic transmitter), or a combination thereof. In an example configuration, input/output system 306 may comprise a Wi-Fi finder, a two-way GPS chipset or equivalent, or the like, or a combination thereof.

Input/output system 306 of network device 300 also may contain a communication connection 308 that allows network device 300 to communicate with other devices, network entities, or the like. Communication connection 308 may comprise communication media. Communication media typically embody computer-readable instructions, data structures, program modules or other data in a modulated data signal such as a carrier wave or other transport mechanism and includes any information delivery media. By way of example, and not limitation, communication media may include wired media such as a wired network or direct-wired connection, or wireless media such as acoustic, RF, infrared, or other wireless media. The term computer-readable media as used herein includes both storage media and communication media. Input/output system 306 also may include an input device 310 such as keyboard, mouse, pen, voice input device, or touch input device. Input/output system 306 may also include an output device 312, such as a display, speakers, or a printer.

Processor 302 may be capable of performing functions associated with telecommunications, such as functions for processing broadcast messages, as described herein. For example, processor 302 may be capable of, in conjunction with any other portion of network device 300, determining a type of broadcast message and acting according to the broadcast message type or content, as described herein.

Memory 304 of network device 300 may comprise a storage medium having a concrete, tangible, physical structure. As is known, a signal does not have a concrete, tangible, physical structure. Memory 304, as well as any computer-readable storage medium described herein, is not to be construed as a signal. Memory 304, as well as any computer-readable storage medium described herein, is not to be construed as a transient signal. Memory 304, as well as any computer-readable storage medium described herein, is not to be construed as a propagating signal. Memory 304, as well as any computer-readable storage medium described herein, is to be construed as an article of manufacture.

Memory 304 may store any information utilized in conjunction with telecommunications. Depending upon the exact configuration or type of processor, memory 304 may include a volatile storage 314 (such as some types of RAM), a nonvolatile storage 316 (such as ROM, flash memory), or a combination thereof. Memory 304 may include additional storage (e.g., a removable storage 318 or a non-removable storage 320) including, for example, tape, flash memory, smart cards, CD-ROM, DVD, or other optical storage, magnetic cassettes, magnetic tape, magnetic disk storage or other magnetic storage devices, USB-compatible memory, or any other medium that can be used to store information and that can be accessed by network device 300. Memory 304 may comprise executable instructions that, when executed by processor 302, cause processor 302 to effectuate operations to map signal strengths in an area of interest.

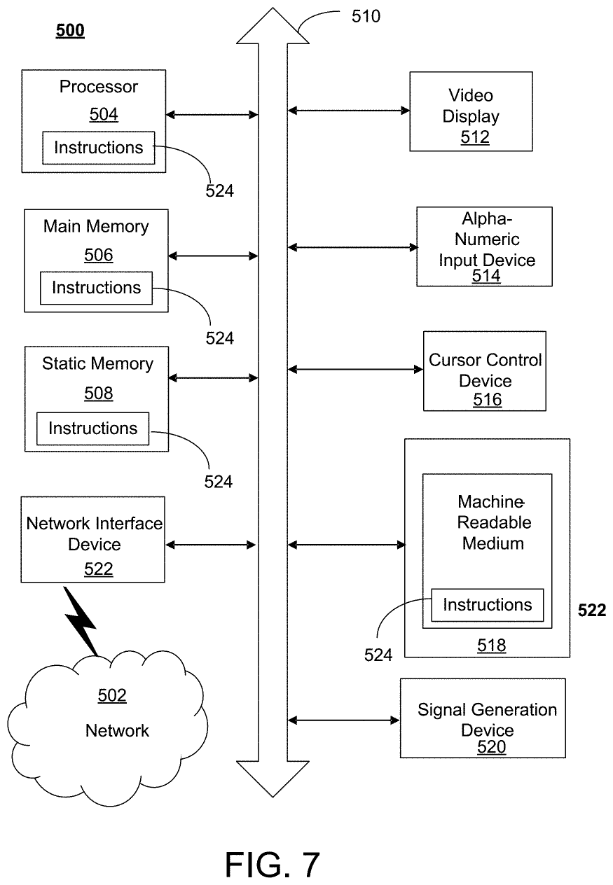

FIG. 7 depicts an exemplary diagrammatic representation of a machine in the form of a computer system 500 within which a set of instructions, when executed, may cause the machine to perform any one or more of the methods described above. One or more instances of the machine can operate, for example, as processor 302, server 99, and other devices of FIG. 1 and FIG. 4. In some embodiments, the machine may be connected (e.g., using a network 502) to other machines. In a networked deployment, the machine may operate in the capacity of a server or a client user machine in a server-client user network environment, or as a peer machine in a peer-to-peer (or distributed) network environment.

The machine may comprise a server computer, a client user computer, a personal computer (PC), a tablet, a smart phone, a laptop computer, a desktop computer, a control system, a network router, switch or bridge, or any machine capable of executing a set of instructions (sequential or otherwise) that specify actions to be taken by that machine. It will be understood that a communication device of the subject disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methods discussed herein.

Computer system 500 may include a processor (or controller) 504 (e.g., a central processing unit (CPU)), a graphics processing unit (GPU, or both), a main memory 506 and a static memory 508, which communicate with each other via a bus 510. The computer system 500 may further include a display unit 512 (e.g., a liquid crystal display (LCD), a flat panel, or a solid state display). Computer system 500 may include an input device 514 (e.g., a keyboard), a cursor control device 516 (e.g., a mouse), a disk drive unit 518, a signal generation device 520 (e.g., a speaker or remote control) and a network interface device 522. In distributed environments, the embodiments described in the subject disclosure can be adapted to utilize multiple display units 512 controlled by two or more computer systems 500. In this configuration, presentations described by the subject disclosure may in part be shown in a first of display units 512, while the remaining portion is presented in a second of display units 512.

The disk drive unit 518 may include a tangible computer-readable storage medium 524 on which is stored one or more sets of instructions (e.g., software 526) embodying any one or more of the methods or functions described herein, including those methods illustrated above. Instructions 526 may also reside, completely or at least partially, within main memory 506, static memory 508, or within processor 504 during execution thereof by the computer system 500. Main memory 506 and processor 504 also may constitute tangible computer-readable storage media.

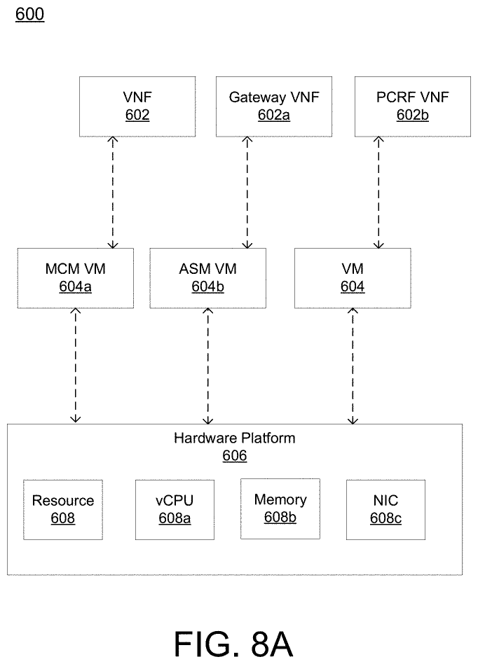

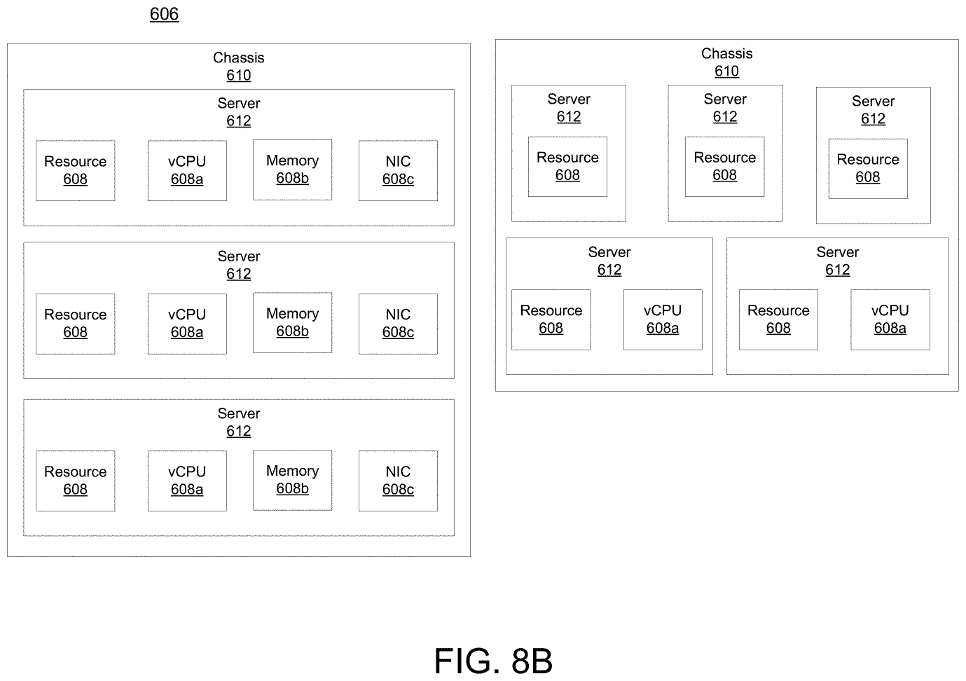

FIG. 8a is a representation of an exemplary network 600. Network 600 (e.g., physical server 99) may comprise an SDN for example, network 600 may include one or more virtualized functions implemented on general purpose hardware, such as in lieu of having dedicated hardware for every network function. For example, general purpose hardware of network 600 may be configured to run virtual network elements to support communication services, such as mobility services, including consumer services and enterprise services. These services may be provided or measured in sessions.

A virtual network functions (VNFs) 602 may be able to support a limited number of sessions. Each VNF 602 may have a VNF type that indicates its functionality or role. For example, FIG. 8a illustrates a gateway VNF 602a and a policy and charging rules function (PCRF) VNF 602b. Additionally or alternatively, VNFs 602 may include other types of VNFs. Each VNF 602 may use one or more virtual machines (VMs) 604 to operate. Each VM 604 may have a VM type that indicates its functionality or role. For example, FIG. 8a illustrates a management control module (MCM) VM 604a, an advanced services module (ASM) VM 604b, and a DEP VM 604c. Additionally or alternatively, VMs 604 may include other types of VMs. Each VM 604 may consume various network resources from a hardware platform 606, such as a resource 608, a virtual central processing unit (vCPU) 608a, memory 608b, or a network interface card (NIC) 608c. Additionally or alternatively, hardware platform 606 may include other types of resources 608.

While FIG. 8a illustrates resources 608 as collectively contained in hardware platform 606, the configuration of hardware platform 606 may isolate, for example, certain memory 608c from other memory 608c. FIG. 8b provides an exemplary implementation of hardware platform 606.

Hardware platform 606 may comprise one or more chasses 610. Chassis 610 may refer to the physical housing or platform for multiple servers or other network equipment. In an aspect, chassis 610 may also refer to the underlying network equipment. Chassis 610 may include one or more servers 612. Server 612 may comprise general purpose computer hardware or a computer. In an aspect, chassis 610 may comprise a metal rack, and servers 612 of chassis 610 may comprise blade servers that are physically mounted in or on chassis 610.

Each server 612 may include one or more network resources 608, as illustrated. Servers 612 may be communicatively coupled together (not shown) in any combination or arrangement. For example, all servers 612 within a given chassis 610 may be communicatively coupled. As another example, servers 612 in different chasses 610 may be communicatively coupled. Additionally or alternatively, chasses 610 may be communicatively coupled together (not shown) in any combination or arrangement.

The characteristics of each chassis 610 and each server 612 may differ. For example, FIG. 8b illustrates that the number of servers 612 within two chasses 610 may vary. Additionally or alternatively, the type or number of resources 610 within each server 612 may vary. In an aspect, chassis 610 may be used to group servers 612 with the same resource characteristics. In another aspect, servers 612 within the same chassis 610 may have different resource characteristics.

Given hardware platform 606, the number of sessions that may be instantiated may vary depending upon how efficiently resources 608 are assigned to different VMs 604. For example, assignment of VMs 604 to particular resources 608 may be constrained by one or more rules. For example, a first rule may require that resources 608 assigned to a particular VM 604 be on the same server 612 or set of servers 612. For example, if VM 604 uses eight vCPUs 608a, 1 GB of memory 608b, and 2 NICs 608c, the rules may require that all of these resources 608 be sourced from the same server 612. Additionally or alternatively, VM 604 may require splitting resources 608 among multiple servers 612, but such splitting may need to conform with certain restrictions. For example, resources 608 for VM 604 may be able to be split between two servers 612. Default rules may apply. For example, a default rule may require that all resources 608 for a given VM 604 must come from the same server 612.

An affinity rule may restrict assignment of resources 608 for a particular VM 604 (or a particular type of VM 604). For example, an affinity rule may require that certain VMs 604 be instantiated on (e.g., consume resources from) the same server 612 or chassis 610. For example, if VNF 602 uses six MCM VMs 604a, an affinity rule may dictate that those six MCM VMs 604a be instantiated on the same server 612 (or chassis 610). As another example, if VNF 602 uses MCM VMs 604a, ASM VMs 604b, and a third type of VMs 604, an affinity rule may dictate that at least the MCM VMs 604a and the ASM VMs 604b be instantiated on the same server 612 (or chassis 610). Affinity rules may restrict assignment of resources 608 based on the identity or type of resource 608, VNF 602, VM 604, chassis 610, server 612, or any combination thereof.

An anti-affinity rule may restrict assignment of resources 608 for a particular VM 604 (or a particular type of VM 604). In contrast to an affinity rule—which may require that certain VMs 604 be instantiated on the same server 612 or chassis 610—an anti-affinity rule requires that certain VMs 604 be instantiated on different servers 612 (or different chasses 610). For example, an anti-affinity rule may require that MCM VM 604a be instantiated on a particular server 612 that does not contain any ASM VMs 604b. As another example, an anti-affinity rule may require that MCM VMs 604a for a first VNF 602 be instantiated on a different server 612 (or chassis 610) than MCM VMs 604a for a second VNF 602. Anti-affinity rules may restrict assignment of resources 608 based on the identity or type of resource 608, VNF 602, VM 604, chassis 610, server 612, or any combination thereof.

Within these constraints, resources 608 of hardware platform 606 may be assigned to be used to instantiate VMs 604, which in turn may be used to instantiate VNFs 602, which in turn may be used to establish sessions. The different combinations for how such resources 608 may be assigned may vary in complexity and efficiency. For example, different assignments may have different limits of the number of sessions that can be established given a particular hardware platform 606.

For example, consider a session that may require gateway VNF 602a and PCRF VNF 602b. Gateway VNF 602a may require five VMs 604 instantiated on the same server 612, and PCRF VNF 602b may require two VMs 604 instantiated on the same server 612. (Assume, for this example, that no affinity or anti-affinity rules restrict whether VMs 604 for PCRF VNF 602b may or must be instantiated on the same or different server 612 than VMs 604 for gateway VNF 602a.) In this example, each of two servers 612 may have sufficient resources 608 to support 10 VMs 604. To implement sessions using these two servers 612, first server 612 may be instantiated with 10 VMs 604 to support two instantiations of gateway VNF 602a, and second server 612 may be instantiated with 9 VMs: five VMs 604 to support one instantiation of gateway VNF 602a and four VMs 604 to support two instantiations of PCRF VNF 602b. This may leave the remaining resources 608 that could have supported the tenth VM 604 on second server 612 unused (and unusable for an instantiation of either a gateway VNF 602a or a PCRF VNF 602b). Alternatively, first server 612 may be instantiated with 10 VMs 604 for two instantiations of gateway VNF 602a and second server 612 may be instantiated with 10 VMs 604 for five instantiations of PCRF VNF 602b, using all available resources 608 to maximize the number of VMs 604 instantiated.

Consider, further, how many sessions each gateway VNF 602a and each PCRF VNF 602b may support. This may factor into which assignment of resources 608 is more efficient. For example, consider if each gateway VNF 602a supports two million sessions, and if each PCRF VNF 602b supports three million sessions. For the first configuration—three total gateway VNFs 602a (which satisfy the gateway requirement for six million sessions) and two total PCRF VNFs 602b (which satisfy the PCRF requirement for six million sessions)—would support a total of six million sessions. For the second configuration—two total gateway VNFs 602a (which satisfy the gateway requirement for four million sessions) and five total PCRF VNFs 602b (which satisfy the PCRF requirement for 15 million sessions)—would support a total of four million sessions. Thus, while the first configuration may seem less efficient looking only at the number of available resources 608 used (as resources 608 for the tenth possible VM 604 are unused), the second configuration is actually more efficient from the perspective of being the configuration that can support more the greater number of sessions.

To solve the problem of determining a capacity (or, number of sessions) that can be supported by a given hardware platform 605, a given requirement for VNFs 602 to support a session, a capacity for the number of sessions each VNF 602 (e.g., of a certain type) can support, a given requirement for VMs 604 for each VNF 602 (e.g., of a certain type), a give requirement for resources 608 to support each VM 604 (e.g., of a certain type), rules dictating the assignment of resources 608 to one or more VMs 604 (e.g., affinity and anti-affinity rules), the chasses 610 and servers 612 of hardware platform 606, and the individual resources 608 of each chassis 610 or server 612 (e.g., of a certain type), an integer programming problem may be formulated.

As described herein, a telecommunications system wherein management and control utilizing a software defined network (SDN) and a simple IP are based, at least in part, on user equipment, may provide a wireless management and control framework that enables common wireless management and control, such as mobility management, radio resource management, QoS, load balancing, etc., across many wireless technologies, e.g. LTE, Wi-Fi, and future 5G access technologies; decoupling the mobility control from data planes to let them evolve and scale independently; reducing network state maintained in the network based on user equipment types to reduce network cost and allow massive scale; shortening cycle time and improving network upgradability; flexibility in creating end-to-end services based on types of user equipment and applications, thus improve customer experience; or improving user equipment power efficiency and battery life—especially for simple M2M devices—through enhanced wireless management.

While examples of a telecommunications system in which enhanced SFC may be processed and managed have been described in connection with various computing devices/processors, the underlying concepts may be applied to any computing device, processor, or system capable of facilitating a telecommunications system. The various techniques described herein may be implemented in connection with hardware or software or, where appropriate, with a combination of both. Thus, the methods and devices may take the form of program code (i.e., instructions) embodied in concrete, tangible, storage media having a concrete, tangible, physical structure. Examples of tangible storage media include floppy diskettes, CD-ROMs, DVDs, hard drives, or any other tangible machine-readable storage medium (computer-readable storage medium). Thus, a computer-readable storage medium is not a signal. A computer-readable storage medium is not a transient signal. Further, a computer-readable storage medium is not a propagating signal. A computer-readable storage medium as described herein is an article of manufacture. When the program code is loaded into and executed by a machine, such as a computer, the machine becomes a device for telecommunications. In the case of program code execution on programmable computers, the computing device will generally include a processor, a storage medium readable by the processor (including volatile or nonvolatile memory or storage elements), at least one input device, and at least one output device. The program(s) can be implemented in assembly or machine language, if desired. The language can be a compiled or interpreted language, and may be combined with hardware implementations.

The methods and devices associated with a telecommunications system as described herein also may be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or the like, the machine becomes an device for implementing telecommunications as described herein. When implemented on a general-purpose processor, the program code combines with the processor to provide a unique device that operates to invoke the functionality of a telecommunications system.

While a telecommunications system has been described in connection with the various examples of the various figures, it is to be understood that other similar implementations may be used or modifications and additions may be made to the described examples of a telecommunications system without deviating therefrom. For example, one skilled in the art will recognize that a telecommunications system as described in the instant application may apply to any environment, whether wired or wireless, and may be applied to any number of such devices connected via a communications network and interacting across the network. Therefore, a telecommunications system as described herein should not be limited to any single example, but rather should be construed in breadth and scope in accordance with the appended claims.

In describing preferred methods, systems, or apparatuses of the subject matter of the present disclosure—enhanced SFC—as illustrated in the Figures, specific terminology is employed for the sake of clarity. The claimed subject matter, however, is not intended to be limited to the specific terminology so selected, and it is to be understood that each specific element includes all technical equivalents that operate in a similar manner to accomplish a similar purpose. In addition, the use of the word “or” is generally used inclusively unless otherwise provided herein.

This written description uses examples to enable any person skilled in the art to practice the claimed invention, including making and using any devices or systems and performing any incorporated methods. The patentable scope of the invention is defined by the claims, and may include other examples that occur to those skilled in the art (e.g., skipping steps, combining steps, or adding steps between exemplary methods disclosed herein). Such other examples are intended to be within the scope of the claims if they have structural elements that do not differ from the literal language of the claims, or if they include equivalent structural elements with insubstantial differences from the literal languages of the claims.

A method, apparatus, or computer readable storage medium for enhanced for service function chain, as disclosed herein. For an apparatus, the operations may include detecting a packet (e.g., an initial packet or packets); processing the packet by a deep packet inspection network function (DPI-NF) of a service function chain, wherein the DPI-NF comprises a plurality of modules, wherein the plurality modules are common modules for a plurality virtual network functions of the service function chain; and based on the processing of the DPI-NF, appending a network service header to the first packet. The operations may further include sending the packet to a first virtual network function of the plurality of network functions, wherein the first virtual network function executes an action based on the network service header. The DPI-NF may be the first network function of the service function chain to process the packet. A list of network service headers and corresponding actions may be periodically sent to the plurality of virtual network functions. A first module of the plurality of modules comprises a module for session identification. The first module of the plurality of modules may include a module for application identification. The matching a policy of a controller with a source internet protocol (IP) address, destination IP address, destination port, and application.

1. An apparatus comprising:
a processor; and
a memory coupled with the processor, the memory storing executable instructions that when executed by the processor cause the processor to effectuate operations comprising:
detecting a packet;
processing the packet by a deep packet inspection network function (DPI-NF) of a service function chain,
wherein the DPI-NF comprises a plurality of modules,
wherein the plurality modules are common modules for a plurality of virtual network functions of the service function chain;
based on the processing of the DPI-NF, appending a network service header to the packet; and
based on the network service header, performing actions by each subsequent virtual network function of the plurality of virtual network functions of the service function chain without executing the common modules for the plurality of virtual network functions of the service function chain.

2. The apparatus of claim 1, the operations further comprising sending the packet to a first virtual network function of the plurality of network functions, wherein the first virtual network function executes an action based on the network service header.

3. The apparatus of claim 1, wherein the DPI-NF is the first network function of the service function chain to process the packet.

4. The apparatus of claim 1, wherein a list of network service headers and corresponding actions are periodically sent to the plurality of virtual network functions.

5. The apparatus of claim 1, wherein the apparatus is a server.

6. The apparatus of claim 1, wherein a first module of the plurality of modules comprises a module for session identification.

7. The apparatus of claim 1, wherein the first module of the plurality of modules comprise a module for application identification.

8. The apparatus of claim 1, the operations further comprising matching a policy of a controller with a source internet protocol (IP) address, destination IP address, destination port, and application.

9. A method comprising:
detecting, by an apparatus, a packet;
processing the packet by a deep packet inspection network function (DPI-NF) of a service function chain,
wherein the DPI-NF comprises a plurality of modules,
wherein the plurality modules are common modules for a plurality of virtual network functions of the service function chain;
based on the processing of the DPI-NF, appending a network service header to the packet; and
based on the network service header, performing actions by each subsequent virtual network function of the plurality of virtual network functions of the service function chain without executing the common modules for the plurality of virtual network functions of the service function chain.

10. The method of claim 9, further comprising sending the packet to a first virtual network function of the plurality of network functions, wherein the first virtual network function executes an action based on the network service header.

11. The method of claim 9, wherein the DPI-NF is the first network function of the service function chain to process the packet.

12. The method of claim 9, wherein a list of network service headers and corresponding actions are periodically sent to the plurality of virtual network functions.

13. The method of claim 9, wherein the apparatus is a server.

14. The method of claim 9, wherein a first module of the plurality of modules comprises a module for session identification.

15. The method of claim 9, wherein the first module of the plurality of modules comprise a module for application identification.

16. The method of claim 9, the operations further comprising matching a policy of a controller with a source internet protocol (IP) address, destination IP address, destination port, and application.

17. A computer readable storage medium storing computer executable instructions that when executed by a computing device cause said computing device to effectuate operations comprising:
detecting a packet;
processing the packet by a deep packet inspection network function (DPI-NF) of a service function chain,
wherein the DPI-NF comprises a plurality of modules,
wherein the plurality modules are common modules for a plurality of virtual network functions of the service function chain;
based on the processing of the DPI-NF, appending a network service header to the packet; and
based on the network service header, performing actions by each subsequent virtual network function of the plurality of virtual network functions of the service function chain without executing the common modules for the plurality of virtual network functions of the service function chain.

18. The computer readable storage medium of claim 17, the operations further comprising sending the packet to a first virtual network function of the plurality of network functions, wherein the first virtual network function executes an action based on the network service header.

19. The computer readable storage medium of claim 17, wherein the DPI-NF is the first network function of the service function chain to process the packet.

20. The computer readable storage medium of claim 17, wherein a list of network service headers and corresponding actions are periodically sent to the plurality of virtual network functions.
